(19) United States
(12) Patent Application Publication
(10) Pub. No.: US 2011/0039122 A1
(43) Pub. Date: Feb. 17, 2011

(54) Method for Producing a Grain-Oriented Magnetic Strip

(75) Inventors: Christof Holzapfel, Gelsenkirchen (DE); Carsten Schepers, Raesfeld (DE); Heiner Schrapers, Duisburg (DE)

Correspondence Address: THE WEBB LAW FIRM, P.C., 700 KOPPERS BUILDING, 436 SEVENTH AVENUE, PITTSBURGH, PA, 15219, US

(73) Assignee: THYSSENKRUPP ELECTRICAL STEEL GMBH, Gelsenkirchen (DE)

(21) Appl. No.: 12/867,133

(22) PCT Filed: Feb. 12, 2009
(86) PCT No.: PCT/EP2009/051627

§ 371 Date: Nov. 3, 2010

(30) Foreign Application Priority Data
Feb. 12, 2008 (DE) 10 2008 008 781.5

(51) Int. Cl. H01F 1/18

(52) U.S. Cl. 428/611; 427/127

(57) ABSTRACT

A method for producing a grain-oriented magnetic strip, covered with a phosphate layer, comprising applying a phosphate solution, which contains a colloid component and at least one colloid stabilizer as an additive to the magnetic strip.

The invention relates to a method for producing a grain-oriented magnetic strip covered with a phosphate layer. The invention also relates to a grain-oriented magnetic strip which is covered with a phosphate layer and can be produced by the method according to the invention, as well as the use of this magnetic strip as the core material in a transformer.

Magnetic strip is a known material in the steel industry with special magnetic properties. The material generally has a thickness of 0.2 mm to 0.5 mm and is produced by a complex production process, consisting of cold rolling and heat treatment processes. The metallurgic properties of the material, the degrees of forming of the cold rolling processes and the parameters of the heat treatment steps are matched to one another in such a way that targeted recrystallisation processes take place. These recrystallisation processes lead to the “Goss texture” typical for the material, in which the direction of easiest magnetizability is in the rolling direction of the finished strips.

The basic material for magnetic strip is a silicon steel sheet. A distinction is made between grain-oriented magnetic strip and non-grain-oriented magnetic strip. In non-grain-oriented magnetic strip, the magnetic flux is not fixed in any specific direction, so equally good magnetic properties are formed in all directions (isotropic magnetisation).

Anisotropic magnetic strip, on the other hand, has a strongly anisotropic magnetic behaviour. This is to be attributed to a uniform orientation of the crystallites (crystallographic texture). In grain-oriented magnetic strip, an effective grain growth selection is carried out by the complex manufacturing. Its grains, with a low faulty orientation in the finally annealed material, have a virtually ideal texture—the “Goss texture” named after its inventor. The surfaces of magnetic strip are generally coated with oxide layers and inorganic phosphate layers. These are to act substantially in an electrically insulating manner.

Grain-oriented magnetic strip is particularly suitable for use purposes, in which a particularly low magnetic loss is important and particularly high demands are made of the permeability or polarisation, such as in power transformers, distribution transformers and high-grade small transformers. The main application for grain-oriented magnetic strip is as the core material in transformers. The cores of the transformers consist of stacked magnetic strip sheets (lamellae). The magnetic strip sheets are stacked in such a way that the rolling direction with the easiest magnetizability is always directed in the direction of the effective coil magnetic field. As a result, the energy loss in magnetic reversal processes in the alternating field is minimal. Owing to this connection, the total energy loss of a transformer inter alia also depends on the quality of the magnetic strip used in the core. Apart from energy losses, the noise development also plays a role in transformers. This is based on a physical effect known as magnetostriction and is inter alia influenced by the properties of the magnetic strip core material used.

To meet these requirements, a two-layered layer system with a ceramic-like layer arranged on the magnetic strip (generally called a glass film) and a phosphate layer arranged on the glass film is generally provided on the surface of grain-oriented magnetic strip. This layer system is to ensure the electric insulation of the lamellae required for use in the stack. However, apart from this insulating property, the magnetic properties of the core material can also be influenced by means of the layer system. The magnetic losses can be again reduced by a tensile stress transmitted by the layer system to the basic material. Moreover, the magnetostriction and therefore the transformer noises are minimised by the tensile stress. In order to utilise these influences, the layer system generally consists of a glass film and a phosphate layer placed thereabove. The two layers are to exert permanent tensile stresses on the metallic core material.

To produce a permanent tensile stress, the phosphate solution according to the prior art may contain a colloid component. The tensile stress is produced by the colloid component and the phosphate itself acts as a binding agent. Systems of this type made of phosphate solutions/colloids are subject to legalities which are combined together in general under the generic term sol/gel transformation and are known in the area of various coating technologies. In the present case it is advantageous if the sol/gel transfer takes place after the application of the phosphate solution on the strip face, in other words during the drying process. The combination of a phosphate with a colloid component is not sufficient to ensure this. The sol/gel transfer is namely sensitively dependent on the pH of the solution, contamination with impurities, in particular extraneous ions, and on the application temperature. In particular for large scale operational applications, pure phosphate/colloid mixtures are too sensitive with regard to their stability.

In order to supply a method which can be stably used in practice, the phosphate/colloid mixtures according to the prior art also have added to them hexavalent chromium, which is generally introduced into the solution as chromium trioxide or chromic acid. For example in DE 22 47 269 a method based on monoaluminum phosphate and silica sol (colloid SiO₂) is protected, whereas 0.2% to 4.5% chromium trioxide or chromate being added in order to be applied in practice. EP 0 406 833 mentions a mixture of a plurality of phosphates and various colloids, again combined with chromium trioxide. EP 0 201 228 describes a mixture of magnesium and aluminium phosphate with highly dispersed SiO₂ powder. This mixture is also enriched with Cr (VI).

Thus, in the prior art, chromium, in particular hexavalent chromium is particularly important in the phosphate coatings of magnetic strip. Chromium is accorded an important role above all when applying phosphate layers in large-scale methods and in phosphate coatings which contain a colloid component to optimise the tensile stress. The use of chromium is therefore particularly emphasised in the prior art because hexavalent chromium improves the ability to apply the phosphate solution to the strip surface and therefore allows the creation of a homogeneous finished strip insulation layer. Furthermore, hexavalent chromium prevents the development of tacky finished strip layers and modifies the interaction of the phosphate solution with the strip material in such a way that no iron goes into solution. Thus a damaging contamination of the phosphate solution with iron ions can be prevented. Finally, hexavalent chromium influences the polymerisation of the colloid solution components in such a way that the latter only takes place at relatively high temperatures when drying the layer. Thus, an uncontrolled polymerisation or gel formation during the application of the phosphate solution to the strip surface—which would inevitably lead to time-consuming production shut-downs—is prevented.

The effect of hexavalent chromium in phosphate/colloid mixtures is substantially based on the fact that the transfer from the sol to the gel is controlled in such a way that it firstly takes place during the drying of the layer during the burning in.

An enormous drawback which comes more and more to the fore over time of the use of chromium-containing solution systems is, however, the fact that hexavalent chromium, in particular, is very toxic and harmful with respect to the environment and water. There are worldwide attempts to eliminate hexavalent chromium compounds from production processes. If a substitution of the chromium is not possible, enormous efforts have to be made during processing with regard to work protection and environmental protection. Apart from safety in the plant, special protective equipment for the protection of people, protective devices for avoiding unintended release, measures for disposal and plans for the event of a fault have to be incorporated into the process. However, despite all the protective measures, there remains a residual risk that cannot be ignored for humans and the environment. Attempts to simply omit hexavalent chromium from the phosphate solution have so far not gone beyond a laboratory scale.

The object of the present invention is to provide a method for producing a phosphate layer on grain-oriented magnetic strip which allows the use of hexavalent chromium to be dispensed with out the aforementioned drawbacks having to be accepted during manufacture. In particular, a homogeneous application of the phosphate solution and therefore homogeneous finished layer qualities are to be achieved.

This object is achieved by a method for producing a grain-oriented magnetic strip coated with a phosphate layer, in which a phosphate solution containing a colloid component and at least one colloid stabiliser (A), as an additive, is applied to the magnetic strip.

According to the invention, the expression “the phosphate solution contains a colloid component” is taken to mean that a fraction of the phosphate solution consists of solid particles or supramolecular aggregates with sizes of a few nanometers to a few micrometers. The size of the colloid component in the phosphate solution preferably fluctuates in the range of 5 nm to 1 μm, preferably in the range of 5 nm to 100 nm, and, in particular, in the range of 10 nm to 100 nm.

The fraction of colloid component in the phosphate solution may vary. The fraction of colloid component in the phosphate solution preferably fluctuates in the range of 5% by weight and 50% by weight, in particular 5% by weight and 30% by weight. The most varied substances can be used as the colloid component. These substances should expediently not be phosphoric acid-soluble.

Good results are above all achieved with oxides, preferably with Cr₂O₃, ZrO, SnO₂, V₂O₃, Al₂O₃, SiO₂, preferably as aqueous suspensions. SiO₂ is excellently suitable, in particular. A particularly suitable colloid component according to the invention is therefore silica sol. Excellent results are achieved with silica sol which has a fraction of SiO₂ in water of 10 to 50% by weight, preferably of 20 to 40% by weight. Particularly expedient particle sizes for SiO₂ are 5 to 30 nm, preferably 10 to 20 nm.

The method according to the invention is distinguished in that the phosphate solution contains a colloid stabiliser (A) as the additive. This conduct of the method can ensure that the transfer from the sol to the gel only takes place during the drying of the phosphate layer. Moreover, the use of colloid stabilisers allows a homogeneous application of the phosphate solution whereby homogeneous finish layer qualities can be achieved. The use of colloid stabilisers (A) therefore allows the use of hexavalent chromium in the phosphate solution to be dispensed with in the phosphate coating of magnetic metal sheet, it being possible to substantially avoid the problems which generally occur in chromium-free manufacture using colloid-containing phosphate solutions.

Additives of Group A are colloid stabilisers. Colloid stabilisers in the sense of the invention are additives which stabilise colloids and prevent an uncontrolled sol/gel transfer or coagulation of the solid material. Colloid stabilisers moreover advantageously ensure temperature insensitivity in the region of use before the application of the phosphate solution and make the system insensitive to extraneous substances, in particular extraneous ions.

According to the invention, the most varied colloid stabilisers may be used if they are stable in acid solutions. Furthermore, it is advantageous if the colloid stabilisers do not disturb the stability of the colloid solution and do not disadvantageously influence the quality of the applied phosphate layer. It is also advantageous if the colloid stabilisers have a toxicity that is as low as possible. Furthermore, the colloid stabiliser used should not interact with the further additives optionally present in the phosphate solution in such a way that the additives are hindered in their individual effect.

Practical tests have shown that electrolytes, surfactants and polymers are particularly suitable colloid stabilisers according to the invention. However, surprisingly, the use of phosphoric acid esters and/or phosphonic acid esters as colloid stabilisers is particularly preferred. The term “phosphoric acid esters” is taken to mean, according to the invention, organic esters of phosphoric acid having the formula OP(OR)₃, which act as colloid stabilisers. The term “phosphonic acid esters” is taken to mean, according to the invention, organic esters of phosphonic acid having the formula R(O)P(OR)₂, which act as colloid stabilisers.

The radicals R may be here, independently of one another, hydrogen, an aromatic or an aliphatic group, although not all the radicals R may simultaneously be hydrogen. The term aliphatic group comprises alkyl, alkenyl and alkinyl groups.

Alkyl groups comprise saturated aliphatic hydrocarbon groups having 1 to 8 carbon atoms. An alkyl group may be straight-chained or branched. Particularly suitable alkyl groups according to the invention are methyl, ethyl, propyl, isopropyl, butyl, isobutyl, sec.-butyl, n-pentyl, n-heptyl. An alkyl group may also be substituted with one or more substituents. Suitable substituents are, in particular, aliphatic radicals. Further suitable substituents are alkoxy groups, nitro groups, sulphoxy groups, mercapto groups, sulphonyl groups, sulphinyl groups, halogen, sulphamide groups, carbobylamino groups, alkoxycarbonyl groups, alkoxyalkyl groups, aminocarbonyl groups, aminosulphonyl groups, aminoalkyl groups, cyanoalkyl groups, alkylsulphonyl groups, sulphonylamino groups and hydroxyl groups.

The expression alkenyl relates to an aliphatic carbon group, which has 2 to 10 carbon atoms and at least one double bond. An alkenyl group may be present straight-chained or branched. Particularly preferred alkenyl groups according to the invention are allyl, 2-butenyl and 2-hexinyl. An alkenyl group may optionally be substituted with one or more substituents. Suitable substituents are those already mentioned above as alkyl substituents.

The term alkinyl relates to an aliphatic carbon group which has 2 to 8 carbon atoms and at least one triple bond. An alkinyl group may be present straight-chained or branched. An alkinyl group may also be present substituted with one or more substituents. Suitable substituents are those already mentioned above as alkyl substituents.

Further suitable substituents for the aliphatic groups are aryl groups, aralkyl groups or cycloaliphatic groups. Aryl relates to monocyclic groups such as, for example, phenyl, bicyclic groups such as, for example, indenyl, naphthalenyl, tricyclic groups such as, for example, fluorenyl or a benzo-linked grouped with three rings. Aryl may also be present substituted with one or more substituents. Suitable substituents are those already mentioned above for alkyl substituents.

Aralkyl relates to an alkyl group, which is present substituted with an aryl group. The expression “cycloaliphatic” designates a saturated or partially unsaturated monocyclic, bicyclic or tricyclic hydrocarbon ring, which is present connected by a single bond to the remainder of the molecule. Cycloaliphatic rings are 3 to 8-membered monocyclic rings and 8 to 12-membered bicyclic rings. A cycloaliphatic group includes a cycloalkyl group and cycloalkenyl groups. Aralkyl may also be present substituted with one or more substituents. Suitable substituents are those already mentioned above as alkyl substituents.

Further suitable substituents for the aliphatic groups are the aforementioned substituents, in which one or more carbon atoms are substituted by hetero atoms.

Particularly suitable according to the invention is the use of phosphoric acid esters. Ethyl phosphates, in particular monoethyl phosphate and/or diethyl phosphate are particularly suitable. The product ADACID VP1225/1 from the company Kebo Chemie is excellently suitable, in particular.

The method according to the invention therefore allows the use of a chromium-free phosphate solution. The phosphate solution may obviously nevertheless contain chromium. However, the use of a phosphate solution with a content of chromium of less than 0.2% by weight, preferably less than 0.1% by weight and in particular less than 0.01% by weight is, however, preferred.

According to a preferred embodiment of the invention, the phosphate solution also contains at least one additive, selected from the group consisting of pickling inhibitors (B) and wetting agents (C). The properties of the grain-oriented magnetic strip produced by the method according to the invention can be still further improved by the use of pickling inhibitors (B) and/or wetting agents (C). Accordingly, the use of a phosphate solution which, in addition to the colloid stabiliser (A), contains at least one pickling inhibitor (B) and at least one wetting agent (C) is particularly preferred according to the invention.

Additives, which belong to the B group, are pickling inhibitors. The term “pickling inhibitors” is taken to mean additives, according to the invention, which influence the chemical interaction of the phosphate solution with the strip surface in such a way that no or only small quantities of iron go into solution. A contamination of the phosphate solution with iron ions is therefore prevented by the use of pickling inhibitors and the phosphate solution has constant properties over a long time. This procedure is advantageous because an enrichment of the phosphate solution with iron reduces the chemical resistance of the phosphate layer on the magnetic strip.

The use of pickling inhibitors in a colloid system proves to be particularly advantageous, as applied according to the invention, as the sol/gel transfer strongly depends on extraneous ions. By adding pickling inhibitors, the stability of the colloid system can consequently be substantially improved.

According to the invention, the most varied additives can be used as the pickling inhibitors (B) if they are stable in acid solutions. It is moreover advantageous if the pickling inhibitor does not disadvantageously influence the quality of the applied phosphate layer. It is also advantageous if the pickling inhibitor has a toxicity that is as low as possible. Basically, the pickling inhibitors used should be adapted to the phosphate solution used.

Furthermore, the pickling inhibitors used should not impair the stability of the colloid constituents. Moreover, the pickling inhibitor used should not interact with the further additives in the phosphate solution in such a way that the additives are hindered with regard to their individual effect.

Practical tests have shown that thiourea derivatives, C₂-₁₀-triazine derivatives, thioglycolic acid, C₁₋₄-alkylamines, hydroxy-C₂₋₈-thiocarboxylic acid and/or fatty alcohol polyglycol ether are particularly effective pickling inhibitors.

Pickling inhibitors in the form of thiourea derivatives, according to the invention, are taken to mean pickling inhibitors which have the thiourea structure as the basic structure. 1 to 4 hydrogen atoms of the thiourea may be replaced by suitable substituents. Particularly suitable substituents according to the invention are aliphatic groups as already defined above.

Further suitable substituents in the nitrogen atoms of the basic thiourea structure are aryl groups, aralkyl groups or cycloaliphatic groups as defined above.

A particularly suitable thiourea derivative according to the invention is C₁₋₆-dialkylthiourea, preferably C₁₋₄-dialkylthiourea. The alkyl substituents are preferably present unsubstituted. The use of diethyl thiourea, in particular 1,3-diethyl-2-thiourea, is quite particularly preferred. Quite particularly suitable is the product Ferropas7578 from the company Alufinish.

Pickling inhibitors that are also particularly suitable according to the invention are C₂₋₁₀-alkynols, in particular C₂₋₆-alkyne diols, alkyne having the aforementioned significance. The alkyne substituents are unsubstituted in C₂₋₆-alkyne diols particularly suitable according to the invention and have a double bond. Still further preferred according to the invention is butin-1,4-diol, in particular but-2-yne-1,4-diol and prop-2-yne-1-ol.

Pickling inhibitors which are also very suitable according to the invention are triazine derivatives. A pickling inhibitor in the form of a triazine derivative is taken to mean, according to the invention, a pickling inhibitor which contains the basic triazine structure. One or more hydrogen atoms of the basic triazine structure may be substituted by suitable substituents in the triazine derivatives which are suitable according to the invention. Suitable substituents are those already mentioned above for alkyl substituents.

Further particularly suitable pickling inhibitors according to the invention are fatty alcohol polyglycol ethers. Fatty alcohol polyglycol ethers are taken to mean, according to the invention, the reaction product from fatty alcohols with an excess of ethylene oxide. Particularly suitable fatty alcohols according to the invention have 6 to 30, preferably 8 to 15 carbon atoms. The fraction of ethylene oxide groups in the polyglycol ether is preferably high enough to make the fatty alcohol polyglycol ether water-soluble. Accordingly, at least as many —O—CH₂—CH₂-groups should preferably be present in the molecule as carbon atoms in the alcohol. Alternatively, the water solubility can also be achieved by suitable substitution, such as, for example, esterification with sulphuric acid and transfer of the ester into the sodium salt. Basically, the hydrogen atoms in the fatty alcohol polyglycol ethers may also be substituted with suitable substituents. Suitable substituents are the substituents already mentioned above for alkyl groups.

Thioglycolic acid, and hexamethylenetetramine are excellently suited for use as a pickling inhibitor.

Additives of Group C are wetting agents. The most varied wetting agents can be used in the method according to the invention as long as they are stable in acid solutions. It is furthermore advantageous if the wetting agents do not disadvantageously influence the quality of the phosphate layer applied. It is also advantageous if the wetting agents have a toxicity that is as low as possible. Moreover, the wetting agents used should not impair the stability of the colloid constituents. Furthermore, the wetting agent used should not interact with the further additives present in the phosphate solution in such a way that the additives are hindered in their individual effect.

The use of wetting agents in the method according to the invention leads to the application of the phosphate solution on the strip surface being improved. Moreover, the homogeneity of the phosphate layer is increased. Practical tests have shown that fluorosurfactants are excellently suited as wetting agents. An advantage of fluorosurfactants is that they can be stably used in the most varied phosphate solutions, even in Cr (VI)-containing phosphate solutions. The most varied fluorosurfactants are suitable as an additive for the method according to the invention. The term fluorosurfactant, according to the invention, is taken to mean a surfactant which has a perfluoroalkyl radical as the hydrophobic group, alkyl having the significance defined above. Fluorosurfactants are distinguished compared to non-fluorinated surfactants in that they already bring about a significant reduction in the surface tension of the water at extremely low concentrations. Moreover, fluorosurfactants have a high chemical and thermal stability. The most varied surfactants are a possible surfactant component of the fluorosurfactant which can preferably be used according to the invention, if they are stable in acid solutions. It is furthermore advantageous if the fluorosurfactants do not impair the stability of the colloid solution and do not disadvantageously influence the quality of the phosphate layer applied. It is furthermore advantageous if the fluorosurfactants have a toxicity which is as low as possible.

Practical tests have shown that C₁₋₄-tetraalkylammoniumperfluoro-C₅₋₁₀-alkylsulphonates are particularly suitable fluorosurfactants according to the invention. A particularly suitable wetting agent is the product NC 709 from the company Schwenk, which contains the tetraethylammonium perfluorooctane sulphonate.

The quantities in which the various additives A to C are contained in the phosphate solution, can be varied within a broad scope. Practical tests have shown that particularly good results are obtained if the colloid stabiliser (A) is used in a quantity of 0.001 to 20% by weight, preferably in a quantity of 0.01 to 10% by weight and, in particular, in a quantity of 0.1 to 2% by weight. The pickling inhibitor (B) is expediently used in the quantity of 0.001 to 10% by weight, preferably in a quantity of 0.005 to 1% by weight and, in particular, in a quantity of 0.01 to 0.08% by weight. The wetting agent (C) is expediently used in a quantity of 0.0001 to 5% by weight, preferably in a quantity of 0.001 to 1% by weight, and in particular, in a quantity of 0.01 to 0.1% by weight, in each case based on the total weight of the phosphate solution.

The phosphate solution according to the invention may contain the most varied phosphates. Thus, the phosphate solution may, for example, contain calcium phosphate, magnesium phosphate, manganese phosphate and/or mixtures thereof. Because of their good water-solubility, primary phosphates (monophosphates) are particularly preferred according to the invention. Particularly good results are achieved with a phosphate solution containing aluminium phosphate and/or magnesium phosphate. Quite particularly preferred are phosphate solutions, which contain Al (H₂PO₄)₃, in particular in a quantity of 40 to 60% by weight.

If a phosphate solution is used, which contains Al(H₂PO₄)₃ as the phosphate and SiO₂ (silica sol) as the colloid component, the following quantity ratio has proved to be particularly suitable:

0.5<Al(H₂PO₄)₃:SiO₂<20, preferably

0.7<Al(H₂PO₄)₃:SiO₂<5, and, in particular

Al(H₂PO₄)₃:SiO₂=1.36

The basis for the phosphate solution is preferably water; however, obviously, other solvents may also be used, if they have a similar reactivity and polarity to water.

The concentration of the phosphate in the phosphate solution is preferably 5 to 90% by weight, according to the invention, preferably 20 to 80% by weight, more preferably 30 to 70% by weight and, in particular 40 to 60% by weight.

A burn-in phosphate coating in the scope of the stress relief annealing has proven particularly suitable in practice for forming the phosphate layer on the magnetic strip. In the burn-in phosphate coating, firstly the phosphate solution is applied to the strip and then burnt in at temperatures of above 700° C., preferably more than 800° C., in particular about 850° C. Burning in in a continuous furnace has proven particularly successful.

As already mentioned above, the phosphate solution contains a colloid component. This embodiment is advantageous as a tensile stress can be transmitted to the magnetic strip with the colloid component during the drying of the phosphate layer. The tensile stress leads to a clear reduction in the magnetic losses when using the magnetic strip. Moreover, the magnetostriction and therefore the occurrence of noise development may be minimised during use in transformers.

A particularly suitable colloid component according to the invention is colloid silicon dioxide. With regard to the stability of the colloid system, apart from the use of a colloid stabiliser, the pH of the phosphate solution is important. In order to increase the stability of the phosphate solution before the drying, pH values of <3, preferably of 0.5 to 1, have proven particularly successful.

A further increase in the tensile stress on the magnetic strip can be brought about in that a glass film is applied between the phosphate layer and magnetic strip. A glass film is taken, according to the invention, to mean a ceramic-like layer, which preferably contains primarily Mg₂SiO₄ and incorporated sulphides. The glass film is preferably formed in a manner known per se during the full annealing from magnesium oxide and silicon oxide.

A further subject of the present invention is a grain-oriented magnetic strip covered with a phosphate layer, which has been produced by the method according to the invention. The magnetic strip according to the invention is distinguished in that the content of chromium in the phosphate layer is less than 0.2% by weight, preferably less than 0.1% by weight.

According to a preferred embodiment of the invention, a glass film is arranged between the phosphate layer and magnetic strip.

The phosphate layer and the optionally present glass film may be arranged on the upper and/or lower side of the magnetic strip. The phosphate layer and glass film are preferably arranged on the upper and lower side of the magnetic strip.

The grain-oriented magnetic strip according to the invention is suitable for the most varied applications. A use of the grain-oriented magnetic strip according to the invention to be particularly emphasised is the use as a core material in a transformer.

The invention will be described in more detail below with the aid of a plurality of exemplary embodiments.

Various additives will be investigated below with regard to the following effects:
interaction of the phosphate solution with a strip surface
colloid-stabilising effect
use property of the phosphate solution.

The following methods were applied here:

Method 1: Evaluation of the Interaction of the Phosphate Solution with a Magnetic Strip Surface

The phosphate solution or the phosphate/colloid mixture is put in a beaker. The additive to be evaluated is then added whilst stirring. A weighed magnetic strip sample with a metallically bare surface is dipped in the solution and weighed after various immersion times. The decrease in weight (pickling loss) is calculated from the measurements. The method is partly carried out at different temperatures.

### Method 2: Evaluation of the Colloid-Stabilising Effect

The phosphate solution or the phosphate/colloid mixture is put in a beaker. The additive to be evaluated is then added whilst stirring. A weighed magnetic strip sample with a metallically bare surface is immersed in the solution. After various exposure times, the cloudiness of the solution is evaluated and controlled with regard to gelling. The test is carried out at various temperatures.

### Method 3: Evaluation of the Colloid-Stabilising Effect

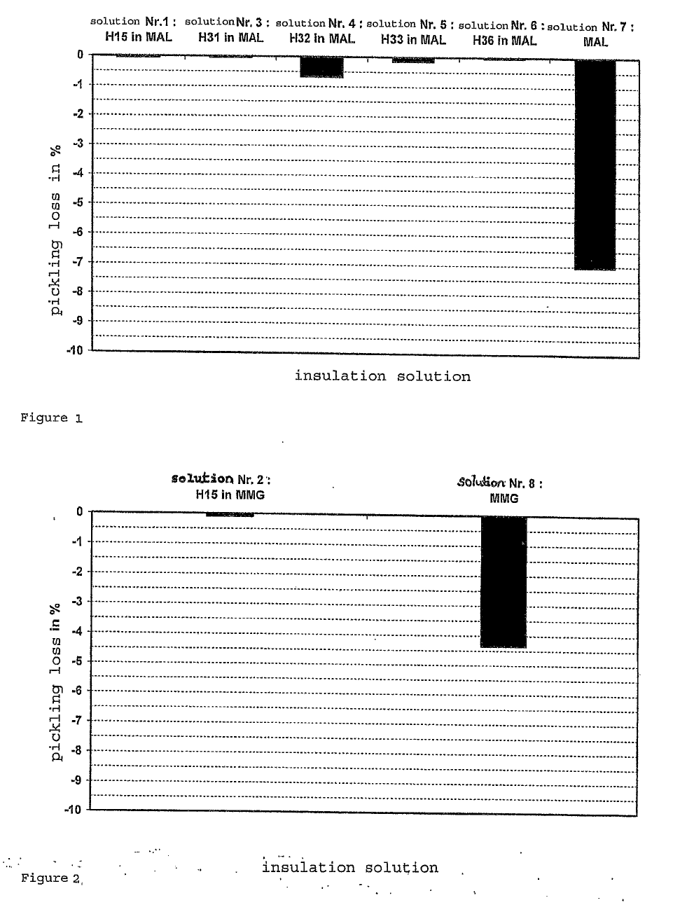

The sol/gel transformation may, as shown by way of example in FIG. 1, be shown very well viscosimetrically.

### Method 4: Evaluation of the Wetting Property

The same volumes of the solutions to be evaluated are placed on a glass disc with millimetre paper below it. After a running time of 10 minutes, the areas over which the liquids have spread out, are determined. For this purpose, the areas are approximated by circular areas and the diameters of the circles are given as the area equivalent.

The following base chemicals were used in the exemplary embodiments:

Monoaluminium phosphate (in brief MAL); an aqueous Al (H₂PO₄)₃ solution with 50 M % Al (H₂PO₄)₃.

Demineralised water: conductivity <15 μs/cm.

Monomagnesium phosphate in brief (MMG); 15 g MgO dissolved in 100 g 75 M % H₃PO₄ and 76 g demineralised water.

Silica sol: aqueous colloid, consisting of 30 M % SiO₂ with an average particle size of 15 nm and a pH of 9.

### EXEMPLARY EMBODIMENT 1

### Effect of Pickling Inhibitors in Phosphate Solutions without a Colloid Component

Pickling inhibitors based on diethyl thiourea (H15), but-2-yne-1,4-diol (H31), hexamethylene tetramine and prop-2-yne-1-ol (H32), but-2-yne-1,4-diol (H33) and fatty alcohol ethoxylate (H36) were used in monoaluminum phosphate solutions (MAL) 50% and monomagnesium phosphate solutions (MMG) 50%.

TABLE 1

| Solution component | | 1 | 2 | 3 | 4 | 5 | 6 | 7 | 8 |
|---|---|---|---|---|---|---|---|---|---|
| MAL | g | 150 | | 150 | 150 | 150 | 150 | 150 | |
| MMG | g | | 150 | | | | | | 150 |
| Demineralised | g | 50 | 50 | 50 | 50 | 50 | 50 | 50 | 50 |
| water | | | | | | | | | |
| H15 | g | 1 | 1 | | | | | | |
| H31 | g | | | 1 | | | | | |
| H32 | g | | | | 1 | | | | |
| H33 | ml | | | | | 1 | | | |
| H36 | ml | | | | | | 1 | | |

MAL = monoaluminium phosphate solutions 50%
MMG = monomagnesium phosphate Mg (H₂PO₄)₂ = 100 g 75% H₃PO₄ + 15 g MgO + 76 g demineralised water
H15 = Ferropas7578, Alufinish, active substance: diethyl thiourea
H31 = Adacid HV 27 N, Kebo Chemie, active substance: but-2-yne-1,4-diol
H32 = Adacid 328, Kebo Chemie, active substances: hexamethylene tetramine, prop-2-yne-1-ol
H33 = Adacid VP 1112, Kebo Chemie, but-2-yne-1,4-diol
H36 = Antifoam 48, Alufinish, active substance: fatty alcohol ethoxylate

The solutions were evaluated according to Method 1 and the results for an action time of 20 hours are shown in FIGS. 1 and 2. It is shown that all the pickling inhibitors used have excellent effectivity in the sample solution. The best effect is shown, however, by additive H15.

### EXEMPLARY EMBODIMENT 2

### Effect of Pickling Inhibitors in Phosphate/Colloid Mixtures

The following phosphate solutions were prepared:

TABLE 2

| Solution component | Basic solution | | | | |
|---|---|---|---|---|---|
| Monoaluminium | g | 90 | 90 | 90 | 90 |
| phosphate 50% | | | | | |
| Silica sol 30% | g | 110 | 110 | 110 | 110 |
| CrO₃ | g | | 7 | | |
| H27 | g | | | 2 | |
| H29 | g | | | | 2 |

H27 = LITHSOLVENT HVS N, Kebo Chemie, active substance: but-2-yne-1,4-diol, ethoxylated
H29 = ADACID RKT 1, Kebo Chemie, active substance: thioglycolic acid

The solutions were evaluated in accordance with Method 1.

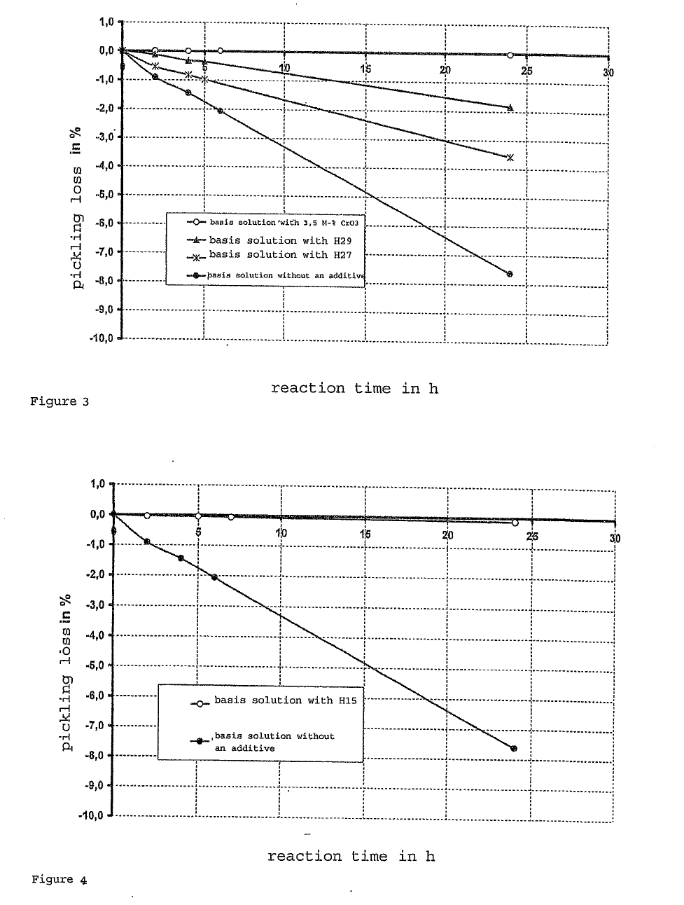

The results of the evaluation are shown in FIG. 3.

Result: The basic solution interacted strongly with the steel sample. The weight reduction of the steel sample is very large which indicates a strong enrichment of the phosphate solution with iron ions. CrO₃ has a strongly pickling inhibiting effect in the solution and therefore prevents the contamination of the phosphate solution with iron ions. The effect can clearly be seen on the sample surfaces. The surface of the sample of the basic solution is matt to black. The sample surface of the solution to which CrO₃ is added is unchanged metallically bare. As emerges from FIG. 3, the additives H27 and H29 act as pickling inhibitors. However, they have smaller pickling-inhibitive effects than CrO₃.

### EXEMPLARY EMBODIMENT 3

### Effect of Pickling Inhibitors in phosphate/colloid mixtures

The following phosphate solutions were prepared:

TABLE 3

| Solution component | Basic solution | | |
|---|---|---|---|
| Monoaluminium phosphate 50% | g | 90 | 90 |
| Silica sol 30% | g | 110 | 110 |
| H15 | g | | 3 |

H15 = Ferropas7578, Alunfinish, active substance: diethyl thiourea

The solutions were evaluated in accordance with Method 1.

The results of the evaluation are shown in FIG. 4.

Result: Additive H15 shows an effect which is comparable with CrO₃. The interaction between the phosphate solution and the steel sample is strongly inhibited. The surface of the sample from the solution with additive H15 remains unchanged over a long period, while the sample from the basic solution has a strong pickling corrosion.

### EXEMPLARY EMBODIMENT 4

### Effect of Pickling Inhibitors in Phosphate/Colloid Mixtures

The following phosphate solutions were prepared:

TABLE 4

| Solution component | Basic solution | | | | | |
|---|---|---|---|---|---|---|
| Monoaluminium | g | 90 | 90 | 90 | 90 | 90 |
| phosphate 50% | | | | | | |
| Silica sol 30% | g | 110 | 110 | 110 | 110 | 110 |
| H25 | g | | 3 | | | |
| H26 | g | | | 3 | | |
| H27 | | | | | 3 | |
| H29 | | | | | | 3 |

H25 = ADACID 337, Kebo Chemie
H26 = KEBOSOL FB, Kebo Chemie
H27 = LITHSOLVENT HVS N, Kebo Chemie, active substance: but-2-yne-1,4-diol, ethoxylated
H29 = ADACID RKT 1, Kebo Chemie, thioglycolic acid

The solutions were evaluated in accordance with Method 1.

The results of the evaluation are shown in FIG. 5.

Result: All the additives act as pickling inhibitors. The effect is below that of the chromium trioxide and additive 15. The decisive observation in the test is that additives can catalyse the sol/gel transformation. In other words, an additive acting as a pickling inhibitor can, on the other hand, accelerate the sol/gel transformation. Additives of this type cannot be used in colloid mixtures.

### EXEMPLARY EMBODIMENT 5

### Effect of Colloid Stabilisers in Phosphate/Colloid Mixtures

The following phosphate solutions were prepared:

TABLE 5

| Solution component | Basic solution | | | | | |
|---|---|---|---|---|---|---|
| Monoaluminium | g | 90 | 90 | 90 | 90 | 90 |
| phosphate 50% | | | | | | |
| Silica sol 30% | g | 110 | 110 | 110 | 110 | 110 |
| H15 | g | | 3 | 3 | 3 | 3 |
| H28 | g | | | 2 | 4 | 6 |

H15 = Ferropas7578, Alufinish, active substance: diethyl thiourea
H28 = ADACID VP 1225/1, Kebo Chemie, active substance: triethyl phosphate

The solutions were evaluated in accordance with Method 2 at a temperature of 50° C.

Result: Additive H15 in the phosphate/silica sol-mixture leads to an inhibition of the pickling reaction, as has already been documented above. Additive H15 does not, however, contribute to the stabilisation of the colloid.

On the other hand, additive H28 acts on the colloid system, in that it obviously delays the polymerisation. An addition of 3 M % leads to the fact that after 8 hours exposure time at 50° C., despite the steel sample located in the solution, the degree of cloudiness had not increased much. The colloid is accordingly still a long way away from the sol/gel transformation.

### EXEMPLARY EMBODIMENT 6

### Effect of the Combination of the Pickling Inhibitor and Colloid Stabiliser in Phosphate/Colloid Mixtures

The following phosphate solutions were prepared:

TABLE 6

| Solution component | Basic solution | | | | |
|---|---|---|---|---|---|
| Monoaluminium | g | 90 | 90 | 90 | 90 |
| phosphate 50% | | | | | |
| Silica sol 30% | g | 110 | 110 | 110 | 110 |
| H15 | g | | 3 | | 3 |
| H28 | | | | 6 | 6 |

H15 = Ferropas7578, Alufinish/Hr. Ritter, active substance: diethyl thiourea
H28 = ADACID VP 1225/1, Kebo Chemie, active substance: triethyl phosphate

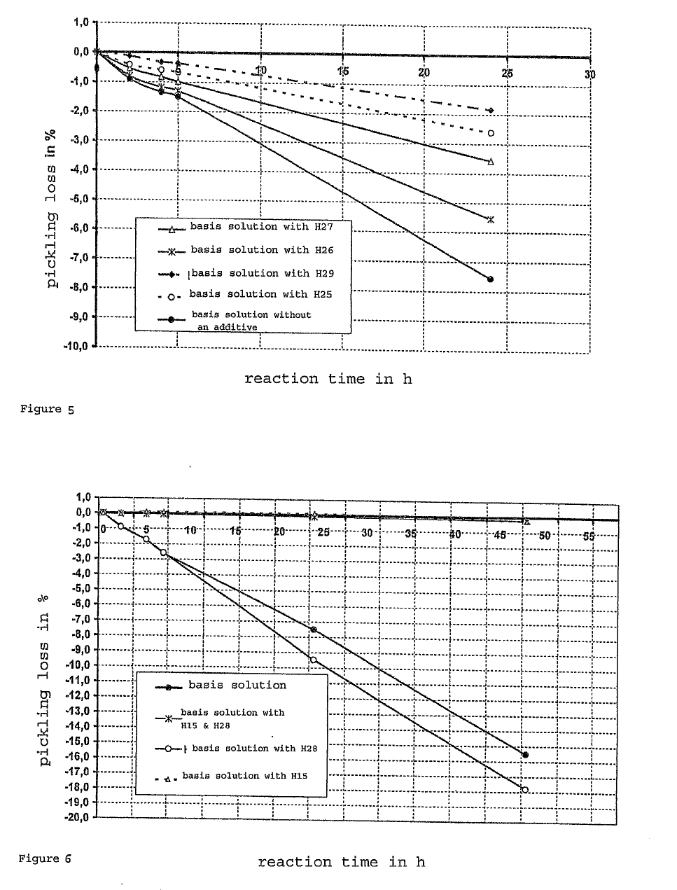

The solutions were evaluated in accordance with Method 1 and 2 at a temperature of 22° C. The results of the evaluations are shown in FIG. 6.

Result: It is shown that when the magnetic strip sample is added to the phosphate solutions, which contain the additive 15, no foam formation occurs. This may be taken as an indicator for the fact that additive 15 unambiguously acts as a pickling inhibitor. The foam formation is namely a result of the hydrogen development from the pickling reaction.

The colloid stabiliser additive H28 has no effect on the chemical interaction of the solution with the steel surface, to be seen by the strong pickling loss in FIG. 6 and by a foam formation on the solution surface. However, the additive acts on the sol/gel transformation in such a way that the transfer to the gel is delayed. This can be seen from the degree of cloudiness of the solutions. The solutions in the beakers, which are doped with additive H28, show a clearly lower degree of clouding than the solutions in the beakers without the additive H28.

This shows that a pickling inhibitor with its special effect can be used combined with a colloid stabiliser and its special effect in a phosphate/colloid mixture, without the two components interacting and without the effects being cancelled or disturbing the colloid system.

Thus two effects of a chemical compound, namely the CrO₃ or hexavalent Cr compounds, are also shown by two separate additives.

### EXEMPLARY EMBODIMENT 7

### Effect of a Colloid Stabiliser in Phosphate/Colloid Mixtures

The following phosphate solutions were prepared:

TABLE 7

| | |
|---|---|
| Solution component | Basic solution |

| | | | | |
|---|---|---|---|---|
| Monoaluminium phosphate 50% | g | 158 | 158 | 158 |
| Silica sol 30% | g | 193 | 193 | 193 |
| Dist. water | g | | 6 | |
| H28 | g | | | 6 |

H28 = ADACID VP 1225/1, Kebo Chemie, active substance: triethyl phosphate

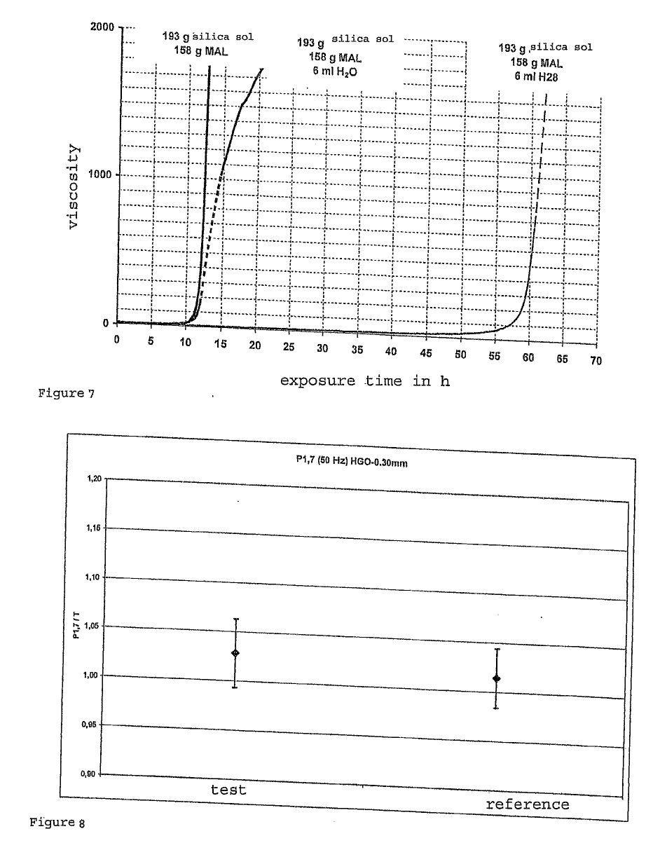

The solutions were evaluated in accordance with Method 3 at a temperature of 50° C. The results of the evaluations are shown in FIG. 7.

Result: The phosphate solution to which additive H28 was added is substantially more stable under the critical conditions for the sol/gel transfer of raised temperature and contamination of the solutions with iron ions. While the sol/gel transformation in the phosphate/colloid mixture already starts after 3 hours, the transfer when using the additive H28 may be shifted to about 6 hours.

### EXEMPLARY EMBODIMENT 8

### Improvement of the Wetting Capacity by the Addition of Wetting Agents

The following phosphate solutions were prepared:

TABLE 8

| Solution component | | 1 | 2 | 3 | 4 | 5 | 6 |
|---|---|---|---|---|---|---|---|
| Monoaluminium | g | 90 | 90 | 90 | 90 | 90 | 90 |
| phosphate 50% | | | | | | | |
| Silica sol 30% | g | 110 | 110 | 110 | 110 | 110 | 110 |
| CrO₃ | g | | | 7 | | | 7 |
| H15 | g | | 2 | | | 2 | |
| H5 | g | | | | 0.5 | 0.5 | 0.5 |

H15 = pickling inhibitor Ferropas7578, Alufinish, active substance: diethyl thiourea
H5 = wetting agent NC 709, Schwenk, active substance: tetraethylammonium perfluorooctane sulphonate

These solutions were evaluated in accordance with Method 4.

TABLE 9

| Solution component | 1 | 2 | 3 | 4 | 5 | 6 |
|---|---|---|---|---|---|---|
| Surface equivalent | 16 | 19 | 18 | 22 | 28 | 27 |

It is shown that the solutions 4 and 5 to which the pickling inhibitor H15 was added clearly improve the wetting capacity of the millimetre paper provided with them. Their action even exceeds that of CrO₃.

### EXEMPLARY EMBODIMENT 9

### Application of the Method According to the Invention in Operational Production

The following phosphate solution was used under operational conditions:

TABLE 10

| Solution component | | |
|---|---|---|
| Monoaluminium phosphate 50% | kg | 450 |
| Silica gel 30% | kg | 550 |
| H15 | kg | 7.5 |
| H28 | kg | 30 |
| H5 | kg | 0.4 |
| Dem. Water | kg | 80 |

H15 = pickling inhibitor Ferropas7578, Alufinish, active substance: diethyl thiourea
H28 = colloid stabiliser ADACID VP 1225/1, Kebo Chemie, active substance: triethyl phosphate
H5 = wetting agent NC 709, Schwenk, active substance: tetraethylammonium perfluorooctane sulphonate

About 850 t magnetic strip of the type PowerCore H 0.30 mm (highly permeable grain-oriented magnetic strip) was treated with this phosphate solution. The mean value of the magnetic losses P_{1.7} in W/kg and the mean value of the specific contact resistances were determined as qualitative features and compared with the data of a reference quantity of about 20,000 t, which was treated with Cr (VI)-containing insulation (cf. FIG. 8).

TABLE 11

| | Magnetic loss | Contact resistance |
|---|---|---|
| Test | 1.028 W/kg ± 0.035 | 82 Ωcm² |
| Reference | 1.014 W/kg ± 0.030 | 31 Ωcm² |

1-19. (canceled)

20. A method for producing a grain-oriented magnetic strip covered with a phosphate layer, comprising applying a phosphate solution, which comprises a colloid component and at least one colloid stabilizer as an additive, to the magnetic strip.

21. The method according to claim 20, wherein the phosphate solution further comprises at least one additive selected from the group consisting of pickling inhibitors and wetting agents.

22. The method according to claim 20, wherein the phosphate solution has a hexavalent chromium content of less than 0.2% by weight.

23. The method according to claim 20, wherein the colloid stabilizer is a phosphoric acid ester.

24. The method according to claim 21, wherein the pickling inhibitor comprises a thiourea derivative, a C₂₋₁₀-alkynol, a triazine derivative, thioglycolic acid, C₁₋₄-alkyl amine, a hydroxyl-C₂₋₈-thiocarboxylic acid, a fatty alcohol polyglycol, or a combination thereof.

25. The method according to claim 21, wherein the pickling inhibitor comprises diethyl thiourea, prop-2-yne-1-ol, butin-1,4-diol, thioglycolic acid, hexamethylenetetramine, or a combination thereof.

26. The method according to claim 21, wherein the wetting agent comprises a fluorosurfactant.

27. The method according to claim 21, wherein the phosphate solution contains at least one pickling inhibitor and at least one wetting agent.

28. The method according to claim 21, wherein the phosphate solution comprises (i) a colloid stabilizer and (ii) a pickling inhibitor, a wetting agent or a combination thereof and wherein the colloid stabilizer is used in a quantity of 0.001 to 20% by weight, the pickling inhibitor is used in a quantity of 0.001 to 10% by weight and the wetting agent is used in a quantity of 0.0001 to 5% by weight, in each case based on the total weight of the phosphate solution.

29. The method according to claim 20, wherein the phosphate solution contains aluminium phosphate, magnesium phosphate, or a combination thereof.

30. The method according to claim 29, wherein the colloid component is colloid silicon dioxide.

31. The method according to claim 20, wherein the phosphate solution has a pH of <3.

32. The method according to claim 20, further comprising applying a glass film between the phosphate layer and magnetic strip.

33. The method according to claim 20, further comprising burning the magnetic strip provided with the phosphate solution at a temperature of more than 800° C.

34. A grain-oriented magnetic strip having a phosphate layer produced by the method according to claim 20.

35. The grain-oriented magnetic strip according to claim 34, wherein the chromium content in the phosphate layer is less than 0.2% by weight.

36. The grain-oriented magnetic strip according to claim 34, wherein a glass film is arranged between the phosphate layer and magnetic strip.

37. The grain-oriented magnetic strip according to claim 36, wherein the phosphate layer, the glass film, or both, are arranged on the upper and lower side of the magnetic strip.

38. A core material in a transformer comprising a grain-oriented magnetic strip according to claim 34.
